(19) United States
(12) Patent Application Publication
(10) Pub. No.: US 2008/0225386 A1
(43) Pub. Date: Sep. 18, 2008

(54) Fiber laser arrangement with regenerative pulse amplification

(76) Inventor: Martin Leitner, Jena (DE)

Correspondence Address: Klaus P. Stoffel;Wolff & Samson, One Boland Drive, West Orange, NJ, 07052, US

(21) Appl. No.: 11/986,761

(22) Filed: Nov. 26, 2007

(30) Foreign Application Priority Data
Nov. 27, 2006 (DE) 10 2006 056 334

(51) Int. Cl. H01S 3/00

(52) U.S. Cl. 359/348

(57) ABSTRACT

A fiber laser arrangement with regenerative pulse amplification, having a femtosecond fiber oscillator as a pulse-generating unit, a fiber amplifier designed both as a pulse-amplifying and pulse-stretching device to amplify and to stretch the femtosecond pulses generated by the femtosecond fiber oscillator, a regenerative amplifier, which has a disk-shaped laser crystal as a gain medium, and which is designed to produce additional pulse stretching during the regenerative amplification, and a pulse compression device, which temporally compresses the amplified and time-stretched pulses.

### BACKGROUND OF THE INVENTION

Regenerative amplifiers are used to achieve high pulse energies in the nanosecond, picosecond, and especially the femtosecond range (M. Leitner, K. Pachomis, D. Nickel, C. Stolzenburg, A. Giesen: “Ultrafast thin disk Yb:KYW regenerative amplifier with 200 kHz repetition rate”, OSA Trends in Optics and Photonics. Vol. 98, Advanced Solid-State Photonics, edited by Irina Sorokina and Craig Denman (Optical Society of America, Washington D.C., 2005), Article ME 5).

Pulses generated by a femtosecond oscillator are coupled by means of rapid electro-optic elements into the regenerative amplifier, which is equipped with an gain medium, amplified by several passes through the gain medium, and coupled out after reaching the desired pulse energy.

The amplification of femtosecond pulses in particular makes it necessary to deal with high pulse peak powers, which can lead to many types of detrimental effects during the amplification process, effects which limit the power scaling of a regenerative amplifier. These effects include:

self-phase modulation.

production of parasitic green light in electro-optic crystals, and

destruction of the optical elements.

To avoid these effects, the so-called CPA (chirped pulse amplification) technique is generally used, in which the femtosecond pulse is time-stretched through positive dispersion by means of a pulse stretching device before being coupled into the regenerative amplifier, and after the amplification process it is compensated again through corresponding negative dispersion in a compression device (see US 2005/0111500 A1, US 2006/0120418 A1).

Strict requirements are imposed on the pulse stretching device, because, if the pulses are stretched too far, nonlinear effects will increase beyond a critical limit during the final passes through the regenerative amplifier, during which maximum pulse energies are reached. Suitable pulse stretching devices consist, as is well known, of active or passive optical fibers or an arrangement of gratings and/or prisms. If the gain media used in the regenerative amplifier also demand a very high temporal stretching of the pulses, not only the requirements on the pulse stretching device but also those on the compression device are increased. Any higher-order dispersive effects which may occur can no longer be compensated under certain conditions, which means that the pulse compression can no longer be complete.

### SUMMARY OF THE INVENTION

The object of the invention is therefore to reduce the complexity of the apparatus required for temporal pulse stretching and to configure this process and the regenerative amplification in such a way that that nonlinear effects are minimized and the detrimental influence of those effects on the usefulness of the regeneratively amplified pulses is thus avoided. In addition, the goal is to achieve oscillator pulses of the highest possible energy.

According to the invention, the task is accomplished by means of a fiber-laser arrangement with regenerative pulse amplification which contains:

femtosecond fiber oscillator as a pulse-generating unit;

a fiber amplifier designed both as a pulse amplification device and as a pulse stretching device to amplify and to time-stretch the femtosecond pulses generated by the femtosecond fiber oscillator;

a regenerative amplifier, which has a disk-shaped laser crystal as a gain medium and which is designed to provide further pulse stretching during regenerative amplification; and

a pulse compression device, which temporally compresses the amplified and time-stretched pulses.

The essential point is that the inventive fiber-laser arrangement with regenerative pulse amplification operates without the addition of a separate complicated and expensive pulse stretching device. The stretching factors (e.g., from 200 fs to 10 ps) which can be achieved with the arrangement are largely sufficient for regenerative amplification with a disk-shaped gain medium.

The fiber oscillator, preferably provided for the 1 micron range, generates stable femtosecond pulses in a range of 100 pJ, which are amplified by the fiber amplifier into the nJ range. During amplification in the fiber amplifier in this energy range, there are still no significant nonlinear effects which can interfere with the further course of the process.

Nonlinear effects are also significantly reduced by the shorter interaction length of the disk-shaped laser crystal. Because, in addition, no dispersion compensation is carried out in the regenerative amplifier, the crystal material such as BBO present in the amplifier resonator leads to additional temporal expansion of the pulse as a result of the path which the pulse takes through the material. The stretching factors occurring in the inventive device are not critical with respect to subsequent compression, because the higher-order dispersive effects are correspondingly small, which means that compression is nearly perfect and thus minimal pulse lengths can be achieved.

It is advantageous for the fiber amplifier to have an amplifier fiber with a length in the range of 2-10 m and with a material dispersion of 15-30 fs²/mm.

The amplification bandwidth provided in the regenerative amplifier is narrower than the spectral bandwidth of the fiber-generated femtosecond pulses. This leads to the result that the spectral bandwidth of the pulse decreases during amplification. The regenerative amplifier can therefore be operated at maximum amplification without the need for precise spectral tuning between the fiber laser and the regenerative amplifier. Whereas the fiber laser can consist of Yb:glass or Er:glass with a device for producing the second harmonic, Yb:KGW or Yb:KYW can be used for the regenerative amplifier.

In a preferred embodiment of the invention, the regenerative amplifier contains a laser crystal designed as a 100-300 μm thick Yb:KYW disk with doping in a range of 5-15%.

It is advantageous for the bandwidth ratio between the spectral bandwidth of the fiber-generated femtosecond pulses and the amplification bandwidth of the disk-shaped amplifier crystal to be in the range of 1.2-2.

The femtosecond fiber oscillator is preferably designed to emit a central wavelength which is situated at the point of maximum amplification of the regenerative amplifier.

The femtosecond fiber oscillator, however, can also be designed to generate femtosecond pulses which are a maximum of ⅕ of their spectral width away from the point of maximum amplification of the regenerative amplifier.

This offers the advantage that the femtosecond fiber oscillator can under certain conditions be designed to emit a central wavelength at which more stable operating behavior is obtained.

If the femtosecond fiber oscillator and the fiber amplifier form a monolithic unit, losses can be minimized and stability can be increased.

It is advantageous for a fast electro-optic switch, provided as a pulse picking device, to be installed between the fiber amplifier and the regenerative amplifier to couple the preamplified and stretched pulses into the regenerative amplifier.

Another object of the invention is a process for generating regeneratively amplified femtosecond pulses which does not use a separate pulse stretching device and in which the pulse stretching of the femtosecond pulses to be regeneratively amplified is carried out by a fiber amplifier connected to a femtosecond fiber oscillator and by crystal material in the regenerative amplifier. In particular, the pulse stretching is carried out with a total stretching factor of no more than 200.

Other features and advantages of the present invention will become apparent from the following description of the invention.

### BRIEF DESCRIPTION OF THE DRAWINGS

The invention is explained in greater detail below on the basis of the schematic drawings:

FIG. 1 shows a femtosecond fiber oscillator, to which a fiber amplifier is connected;

FIG. 2 shows a wavelength spectrum generated by a femtosecond fiber oscillator according to FIG. 1; and

FIG. 3 shows a laser arrangement consisting of a femtosecond fiber oscillator, to which a fiber amplifier is connected, and a regenerative amplifier with disk-shaped laser crystal.

### DETAILED DESCRIPTION OF THE INVENTION

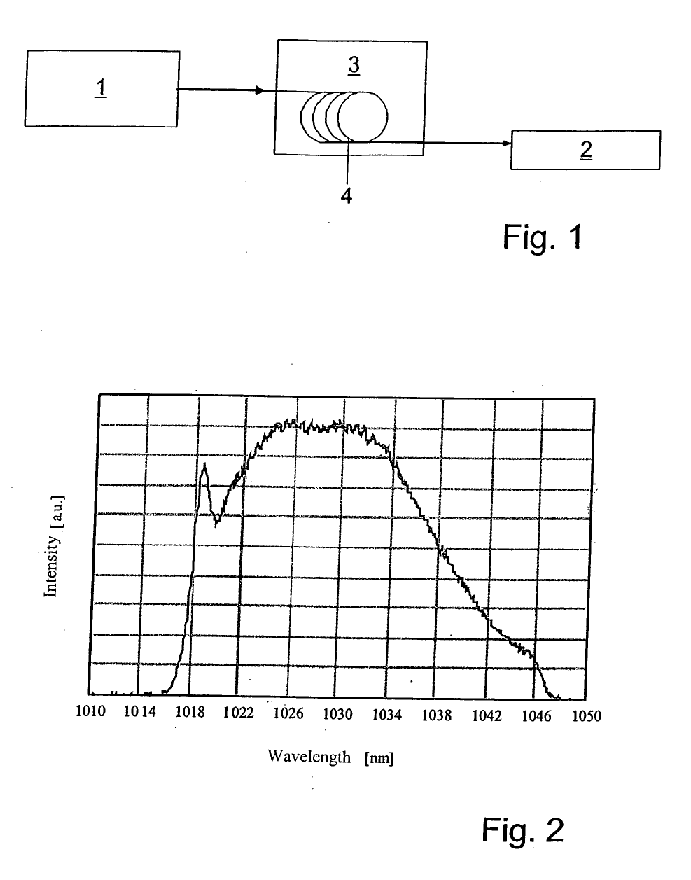

The fiber oscillator shown in FIG. 1 is a passive mode-locked femtosecond fiber oscillator 1 designed for parabolic pulse generation. This oscillator is intended to generate bandwidth-limited femtosecond pulses with typical pulse durations of 250 fs, pulse energies of several nanojoules, and a repetition rate of 50 MHz. The femtosecond fiber oscillator 1 with a central wavelength which lies at the point of maximum amplification of a regenerative amplifier 2 (1025 nm for Yb:KYW) consists of a ring resonator with conventional active (Yb) and passive fibers. The dispersion compensation in the resonator of the femtosecond fiber oscillator 1 is realized by means of a reflection grating. Femtosecond pulses with a pulse duration of Tin are generated in the femtosecond fiber oscillator 1 on the basis of the principle of parabolic pulse formation. Some of these are then coupled out by way of a fiber network and amplified in a fiber amplifier 3 with an amplifying fiber 4, which consists of a Yb-doped glass fiber pumped with diode modules. The amplifying fiber 4 is designed in such a way that the femtosecond pulses are time-stretched on the basis of the material dispersion β₂. By way of approximation, the pulse duration of the stretched pulses, which is a function of the pulse duration Tin of the femtosecond pulses, of the material dispersion β₂, and of the fiber length l_{Faser}, is founded to be:

$${τ}_{in} \cdot \sqrt{1 + {[ \frac{{β}_{2} \cdot {1}_{Faser}}{{( \frac{{τ}_{in}}{2 \cdot \sqrt{ln ( 2 )}} )}^{2}} ]}^{2}} .$$

As a result, for a fiber length l_{Faser} of approximately 10 m and a material dispersion β₂ of 16.4 fs²/mm, a femtosecond pulse which leaves the femtosecond fiber oscillator 1 with a pulse duration of approximately 90 fs is stretched to a pulse duration of approximately 5.1 ps.

By designing the fiber amplifier 3 as a pulse stretching device in this way, it is therefore possible for the femtosecond pulses generated by the femtosecond fiber oscillator 1 to be stretched by a factor of 40-60 without the addition of dispersive elements such as passive fibers or gratings.

It must be kept in mind that the amplifier fiber 4 can be lengthened to increase the pulse energy only to the extent that no interfering nonlinear effects occur as a result of the interaction length. The fiber amplifier 3 is also to be dimensioned so that higher-order dispersive effects which cannot be compensated during compression are minimized.

As already disclosed, the femtosecond fiber oscillator 1 is preferably operated with parabolic pulse formation so that relatively high pulse energies can be generated in a stable manner. A typical wavelength spectrum generated by a laser oscillator according to the present embodiment is shown in FIG. 2. It is important that the spectral bandwidth, namely, 22 nm, is much wider than the amplification bandwidth of the active laser material (approximately 16 nm, maximum at 1025 nm for Yb:KYW) of the downline regenerative amplifier 2. Exact tuning of the oscillator spectrum to within a few nanometers is therefore not necessary, because the amplification bandwidth will be covered in any case.

The sideband occurring at 1018.7 nm, which is not part of the pulsed power of the laser but which represents instead a cw (continuous wave) background, does not enter into the amplification process of the regenerative amplifier 2, as a result of which a parasitic degradation of the amplification in the regenerative amplifier 2 is avoided. Nonlinear temporal phase behavior at the pulse flanks can also be spectrally filtered out, so that the amplified pulses have a nearly perfect linear phase course overall, which in turn can be compressed in optimum fashion.

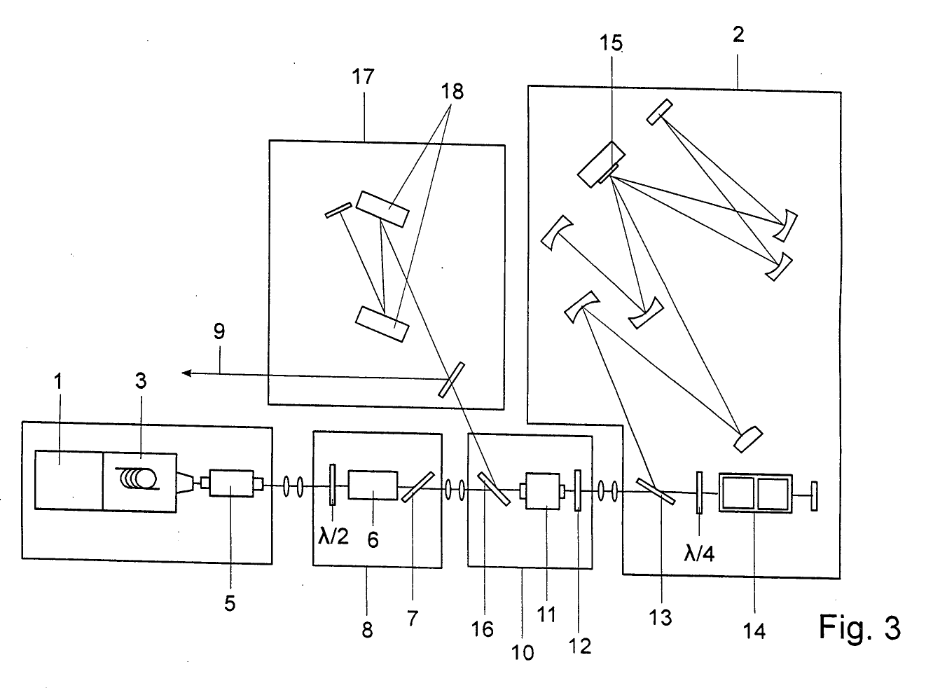

According to FIG. 3, the femtosecond pulses serving as seed pulses are sent by way of a Faraday isolator 5 to a fast optical switch designed as an RTP Pockels cell 6, followed by a thin-layer polarizer 7; this switch operates as a pulse picker device 8, which selects individual pulses so that the fast-repeating pulsed background can be decreased. This prevents seed pulses from being superimposed on the amplified output beam 9 and thus exerting thermal effects on the application. The mode radius of the seed pulses is adapted to the pulse picker device 8 by a suitable optical arrangement.

By means of a separation unit 10, consisting of a Faraday rotator 11 and a λ/2 plate 12, the individual pulse is coupled into the regenerative amplifier 2 by way of a thin-layer polarizer 13. Through the accurately timed activation of the Pockels cell 14, the pulse is directed into the regenerative amplifier 2 so that it can be amplified successively over the course of repeated passes.

The regenerative amplifier 2 contains a laser crystal 15, which is preferably designed as a 100-300 μm thick Yb:KYW disk with doping in the range of 5-15%. Because of the low amplification of the disk material, the pulse is sent through the laser crystal 15 twice. An optical pump system built up of prisms and parabolic mirrors makes it possible to obtain a large number of pump light pass-throughs (preferably 24), which ensures effective absorption and the achievement of a high pump power density as required for a quasi-three-level system. High-power diode lasers provide pump radiation at 980 nm.

As a result of passage of the beam through the Pockels cell 14 and especially in the present case as a result of the relatively long path through the BBO crystal material used in the present exemplary embodiment, further continuous dispersive pulse stretching occurs, because no negatively dispersive elements are present in the regenerative amplifier 2.

The time stretching of the pulses in the fiber amplifier, in combination with the additional dispersive expansion during the amplification in the regenerative amplifier, leads to a stretching factor of up to 200, which is sufficient to produce a significant reduction of the nonlinear effects such as self-phase modulation (SPM), the Raman effect, and self-focusing (SF), which otherwise would have detrimental effects on the shape of the pulse or on the path of the beam. In addition, as a result of the significant reduction in the peak pulse power, especially at the high pulse energies during the last passes through the amplifier, it is also possible to avoid the destruction of the optical elements. The pulse expansion, depending on the number of passes, leads to pulse durations of a few picoseconds, in particular to durations of 3-20 ps.

After reaching the desired pulse energy, which is in the range of several μJ to 100 μJ, the Pockels cell 14 is turned off so that the amplified pulse can be coupled out. After passage through the Faraday rotator 11, it is separated from the seed beam by a thin-layer polarizer 16.

For recompression of the amplified pulses, an arrangement with negative dispersion is provided as a pulse compression device 17. The device consists of a pair of gratings 18 with 600 l/mm, for example, in a Littrow arrangement. By means of a suitably selected beam diameter, it is possible to avoid almost all of the thermally induced degradation of beam quality. In addition, the pulse compression device 17 offers the possibility of overcompensation to take into account the dispersion of downline optical systems.

The pulse compression device can be omitted if this is advantageous for certain applications. The pulses will then be longer, i.e., in a range of 5-15 ps.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A fiber laser arrangement with regenerative pulse amplification, comprising:
a femtosecond fiber oscillator as a pulse-generating unit;
a fiber amplifier designed both as a pulse-amplifying and pulse-stretching device to amplify and to stretch femtosecond pulses generated by the femtosecond fiber oscillator;
a regenerative amplifier, which has a disk-shaped laser crystal as a gain medium, and which is designed to produce additional pulse stretching during regenerative amplification; and
a pulse compression device, which temporally compresses the amplified and time-stretched pulses.

2. The fiber laser arrangement according to claim 1, wherein the fiber amplifier has an amplifying fiber with a fiber length in a range of 2-10 m and a material dispersion of 15-30 fs²/mm.

3. The fiber laser arrangement according to claim 2, wherein crystal material is present in the regenerative amplifier, the crystal material being designed to serve as a path along which the pulse travels for further pulse stretching.

4. The fiber laser arrangement according to claim 3, wherein the disk-shaped laser crystal consists of a material with an amplification bandwidth which is narrower than the bandwidth of the femtosecond pulses generated by the femtosecond fiber oscillator.

5. The fiber laser arrangement according to claim 4, wherein the bandwidth ratio between the spectral bandwidth of the fiber-generated femtosecond pulses and the amplification bandwidth of the disk-shaped laser crystal is in a range of 1.2-2.

6. The fiber laser arrangement according to claim 5, wherein the regenerative amplifier contains a laser crystal designed as a 100-300-μm-thick Yb:KYW disk with doping in a range of 5-15%.

7. The fiber laser arrangement according to claim 6, wherein the femtosecond fiber oscillator is designed to emit a central wavelength which lies at a point of maximum amplification of the regenerative amplifier.

8. The fiber laser arrangement according to claim 6, wherein the femtosecond fiber oscillator is designed to generate femtosecond pulses which are no more than ⅕ of their spectral width away from a point of maximum amplification of the regenerative amplifier.

9. The fiber laser arrangement according to claim 1, wherein the femtosecond fiber oscillator and the fiber amplifier form a monolithic unit.

10. The fiber laser arrangement according to claim 1, and further comprising a fast electro-optic switch serving as a pulse picker device provided between the fiber amplifier and the regenerative amplifier to couple preamplified and stretched pulses into the regenerative amplifier.

11. A process for generating regeneratively amplified femtosecond pulses by means of a fiber laser arrangement with regenerative pulse amplification, the laser arrangement including a femtosecond fiber oscillator as a pulse-generating unit, a fiber amplifier designed both as a pulse-amplifying and pulse-stretching device to amplify and to stretch femtosecond pulses generated by the femtosecond fiber oscillator, a regenerative amplifier, which has a disk-shaped laser crystal as a gain medium, and which is designed to produce additional pulse stretching during regenerative amplification, and a pulse compression device, which temporally compresses the amplified and time-stretched pulses, the process comprising stretching the femtosecond pulses to be regeneratively amplified by means of the fiber amplifier and by crystal material in the regenerative amplifier.

12. The process according to claim 11, wherein the pulse stretching is carried out with an overall stretching factor of no more than 200.
